(19) United States
(12) Patent Application Publication
(10) Pub. No.: US 2025/0168683 A1
(43) Pub. Date: May 22, 2025

(54) REPORTING MAXIMUM DURATION OF A JOINT CHANNEL ESTIMATION

(71) Applicant: Beijing Xiaomi Mobile Software Co., Ltd., Beijing (CN)

(72) Inventor: Shengxiang GUO, Beijing (CN)

(73) Assignee: Beijing Xiaomi Mobile Software Co., Ltd., Beijing (CN)

(21) Appl. No.: 18/839,973

(22) PCT Filed: Feb. 21, 2022
(86) PCT No.: PCT/CN2022/077146

§ 371 Date: Aug. 20, 2024

(51) Int. Cl. H04W 24/10; H04L 25/02

(52) U.S. Cl. CPC H04W 24/10; H04L 25/0204

(57) ABSTRACT

A method for reporting a maximum duration of joint channel estimation includes: receiving a first message sent by a network side device, the first message being used for instructing the terminal device to report the maximum duration of the joint channel estimation; and sending the maximum duration to the network side device. The terminal device reports the maximum duration of the joint channel estimation, so as to enable the network side device to take the maximum duration as a reference value of the time window for the joint channel estimation of the terminal, and configure a length of the time window for a retransmission of the joint channel estimation for the terminal device based on the reference value.

### CROSS-REFERENCE OF RELATED APPLICATION

The present application is a U.S. National Stage of International Application No. PCT/CN2022/077146, filed on Feb. 21, 2022, the contents of all of which are incorporated herein by reference in their entireties for all purposes.

### BACKGROUND

A coverage area is an important factor for an operator to consider when deploying a commercial cellular wireless communication system as it directly affects the operator's quality of service (QOS), capital expenditure (CAPEX) and operating expenditure (OPEX).

### SUMMARY OF THE INVENTION

The disclosure relates to the field of communications, in particular to a method and apparatus, a communication apparatus, and a storage medium for reporting a maximum duration of a joint channel estimation. Examples of the disclosure provide a method for reporting a maximum duration of a joint channel estimation, and an apparatus thereof. A terminal device reports the maximum duration of the joint channel estimation to a network side device, so that the network side device uses the maximum duration as a reference value of a time window for the joint channel estimation of the terminal, and configures a length of the time window for a retransmission of the joint channel estimation for the terminal device based on the reference value, thus the performance of the uplink channel estimation of a communication system as well as the uplink coverage are improved.

According to a first aspect of the disclosure, a method for reporting a maximum duration of a joint channel estimation is provided. The method is executed by a terminal device and includes: receiving a first message sent by a network side device, the first message is used for instructing the terminal device to report the maximum duration of the joint channel estimation; and, sending the maximum duration to the network side device.

The terminal device reports the maximum duration of the joint channel estimation, so that the network side device uses the maximum duration as a reference value of the time window for the joint channel estimation of the terminal, and configures a length of the time window for a retransmission of the joint channel estimation for the terminal device based on the reference value, thus the performance of the uplink channel estimation of the communication system as well as the uplink coverage are improved.

According to a second aspect of the disclosure, a method for obtaining a maximum duration of a joint channel estimation is provided. The method is executed by a network side device and includes: sending a first message to a terminal device; the first message is used for instructing the terminal device to report the maximum duration of the joint channel estimation; and receiving the maximum duration sent by the terminal device.

According to a third aspect of the disclosure, a communication apparatus is provided. The communication apparatus is equipped with some or all of functions for implementing the terminal device in the method according to the first aspect, e.g., the communication apparatus may have the functions in some or all of the examples in the disclosure, or may have the function for implementing any one of the examples in the disclosure alone. The functions may be implemented by hardware or by hardware executing corresponding software. The hardware or software includes one or more units or modules corresponding to the functions.

According to a fourth aspect of the disclosure, another communication apparatus is provided. The communication apparatus is equipped with some or all of functions for implementing the network side device in the method examples according to the second aspect, e.g., the functions of the communication apparatus may have the functions in some or all of the examples in the disclosure, or may have a function for implementing any one of the examples in the disclosure alone. The functions may be implemented by hardware or by hardware executing corresponding software. The hardware or software includes one or more units or modules corresponding to the functions.

According to a fifth aspect of the disclosure, a communication apparatus is provided. The communication apparatus includes a processor. When calling a computer program in a memory, the processor executes the method according to the first aspect.

According to a sixth aspect of the disclosure, a communication apparatus is provided. The communication apparatus includes a processor. When calling a computer program in a memory, the processor executes the method according to the second aspect.

According to a seventh aspect of the disclosure, a communication apparatus is provided. The communication apparatus includes a processor and a memory. A computer program is stored in the memory, and the processor executes the computer program stored in the memory so as to enable the communication apparatus to execute the method according to the first aspect.

According to an eighth aspect of the disclosure, a communication apparatus is provided. The communication apparatus includes a processor and a memory. A computer program is stored in the memory, and the processor executes the computer program stored in the memory so as to enable the communication apparatus to execute the method according to the second aspect.

According to a ninth aspect of the disclosure, a communication apparatus is provided. The apparatus includes a processor and an interface circuit. The interface circuit is used for receiving a code instruction and transmitting it to the processor. The processor is used for running the code instruction so as to enable the apparatus to execute the method according to the first aspect.

According to a tenth aspect of the disclosure, a communication apparatus is provided. The apparatus includes a processor and an interface circuit. The interface circuit is used for receiving a code instruction and transmitting it to the processor. The processor is used for running the code instruction so as to enable the apparatus to execute the method according to the second aspect.

According to an eleventh aspect of the disclosure, a communication system is provided. The system includes the communication apparatus according to the third aspect and the communication apparatus according to the fourth aspect, or the system includes the communication apparatus according to the fifth aspect and the communication apparatus according to the sixth aspect, or the system includes the communication apparatus according to the seventh aspect and the communication apparatus according to the eighth aspect, or the system includes the communication apparatus according to the ninth aspect and the communication apparatus according to the tenth aspect.

According to a twelfth aspect of the disclosure, a non-transitory computer readable storage medium is provided for storing an instruction used by the terminal device. When executed, the instruction enables the terminal device to execute the method according to the first aspect.

According to a thirteenth aspect of the disclosure, a non-transitory computer-readable storage medium is provided for storing an instruction used by the network side device. When executed, the instruction enables the network side device to execute the method according to the second aspect.

According to a fourteenth aspect of the disclosure, a computer program product including a computer program is further provided. When run on a computer, the computer program product enables the computer to execute the method according to the first aspect.

According to a fifteenth aspect of the disclosure, a computer program product including a computer program is further provided. When run on a computer, the computer program product enables the computer to execute the method according to the second aspect.

According to a sixteenth aspect of the disclosure, a chip system is provided. The chip system includes at least one processor and an interface and is used for supporting a terminal device in implementing the functions involved in the first aspect, such as determining or processing at least one of data and information involved in the methods. In a possible design, the chip system further includes a memory. The memory is used for storing necessary computer programs and data of the terminal device. The chip system may consist of a chip, or may also include a chip and other discrete devices.

According to a seventeenth aspect of the disclosure, a chip system is provided. The chip system includes at least one processor and an interface and is used for supporting a network side device in implementing the functions involved in the second aspect, such as determining or processing at least one of data and information involved in the methods. In a possible design, the chip system further includes a memory. The memory is used for storing necessary computer programs and data of the network side device. The chip system may consist of a chip, or may also include a chip and other discrete devices.

According to an eighteenth aspect of the disclosure, a computer program is provided. When run on a computer, the computer program enables the computer to execute the method according to the first aspect.

According to a nineteenth aspect of the disclosure, a computer program is provided. When run on a computer, the computer program enables the computer to execute the method according to the second aspect.

### BRIEF DESCRIPTION OF DRAWINGS

In order to more clearly illustrate technical solutions in examples or background of the disclosure, accompanying drawings required to be used in the examples or background of the disclosure will be described.

FIG. 1 is a schematic diagram of a communication system provided by an example of the disclosure.

FIG. 2 is a flowchart of a method for reporting a maximum duration of a joint channel estimation provided by an example of the disclosure.

FIG. 3 is a flowchart of another method for reporting a maximum duration of a joint channel estimation provided by an example of the disclosure.

FIG. 4 is a flowchart of yet another method for reporting a maximum duration of a joint channel estimation provided by an example of the disclosure.

FIG. 5 is a flowchart of yet another method for reporting a maximum duration of a joint channel estimation provided by an example of the disclosure.

FIG. 6 is a flowchart of method for obtaining a maximum duration of a joint channel estimation provided by an example of the disclosure.

FIG. 7 is a flowchart of another method for obtaining a maximum duration of a joint channel estimation provided by an example of the disclosure.

FIG. 8 is a flowchart of yet another method for obtaining a maximum duration of a joint channel estimation provided by an example of the disclosure.

FIG. 9 is a flowchart of yet another method for obtaining a maximum duration of a joint channel estimation provided by an example of the disclosure.

FIG. 10 is a flowchart of yet another method for obtaining a maximum duration of a joint channel estimation provided by an example of the disclosure.

FIG. 11 is a schematic structural diagram of a communication apparatus provided by an example of the disclosure.

FIG. 12 is a schematic structural diagram of another communication apparatus provided by an example of the disclosure.

FIG. 13 is a schematic structural diagram of a chip provided by an example of the disclosure.

### DETAILED DESCRIPTION OF THE INVENTION

Examples of the disclosure are described in detail below, and instances of the examples are shown in accompanying drawings, where the same or similar reference numerals represent the same or similar elements or elements with the same or similar functions all the time. The examples described below with reference to the accompanying drawings are illustrative, intended to explain the disclosure, and not to be construed as a limitation of the disclosure.

Compared to a 4G long term evolution (LTE) system, a 5th generation mobile communication technology (5G) new radio (NR) system has a greater path loss due to the use of a higher frequency spectrum, which poses a greater challenge to the coverage of the 5G system, especially to the uplink coverage ability. Improving uplink channel estimation performance plays an important role in improving the uplink coverage. Joint channel estimation is proposed in a new generation version of communication technology to enhance a coverage range of a physical uplink shared channel (PUSCH). For a joint channel estimation, both a base station and a terminal (user equipment (UE)) need a time window during which the UE needs to maintain power consistency and phase continuity so as to cooperate with the base station to execute the joint channel estimation in the time window. The performance of the joint channel estimation is related to the size of the time window, so how to improve the performance of an uplink channel estimation of a communication system has become an urgent problem to be solved.

In order to better understand the methods for reporting a maximum duration of a joint channel estimation disclosed by examples of the disclosure, a communication system used in the examples of the disclosure is first described.

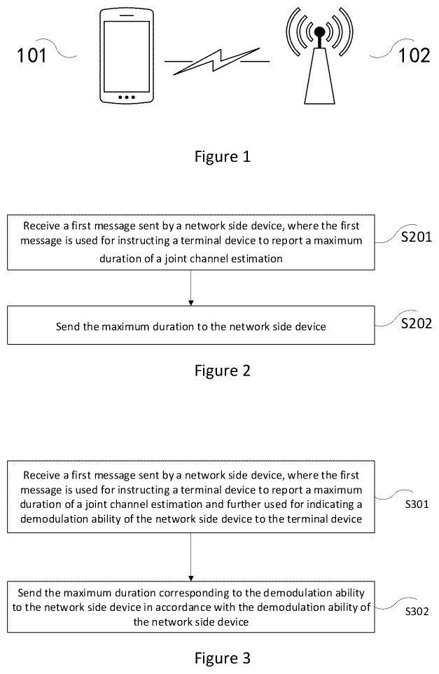

Referring to FIG. 1, FIG. 1 is a schematic architecture diagram of a communication system provided by an example of the disclosure. The communication system includes but is not limited to a terminal device and a network side device. The number and forms of devices shown in FIG. 1 are merely for example and do not constitute a limitation of the example of the disclosure, and two or more terminal devices and two or more network side devices may be included in actual implementation. The communication system shown in FIG. 1 is exemplified by including a terminal device 101 and a network side device 102.

The terminal device 101 in the example of the disclosure is an entity on a user side used for receiving or transmitting a signal, such as a mobile phone. A data receiving end (the terminal device 101) may also be called a terminal, user equipment (UE), a mobile station (MS), a mobile terminal (MT), etc. The data receiving end may be a car with a communication function, a smart car, a mobile phone, a wearable device, a pad, a computer with a wireless transceiving function, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc.

The network side device 102 in the example of the disclosure is an entity on a network side and used for transmitting or receiving a signal. For example, the network side device 102 may be an evolved NodeB (eNB), a transmission reception point (TRP), a next generation NodeB (gNB) in an NR system, a base station in other future mobile communication systems, or an access node in a wireless fidelity (WiFi) system, etc. The example of the disclosure does not limit a specific technology and specific device form adopted for a data sending end. The data sending end provided by the example of the disclosure may be composed of a centralized unit (CU) and a distributed unit (DU), where the CU may also be referred to as a control unit. Adopting a CU-DU structure may divide the data sending end, e.g., a protocol layer of the base station. A function of part of the protocol layer is placed in the CU for a centralized control. A function of part or all of the rest of the protocol layer is distributed in the DU, and the DU is centrally controlled by the CU.

It may be understood that the communication system described in the example of the disclosure is to more clearly illustrate the technical solutions of the example of the disclosure, and does not constitute a limitation on the technical solutions provided by the example of the disclosure. It may be known to those ordinarily skilled in the art that with the evolution of a system architecture and the emergence of new business scenarios, the technical solutions provided by the example of the disclosure are also suitable for similar technical problems.

The method for reporting the maximum duration of joint channel estimation, a communication apparatus, and a storage medium provided by the disclosure are introduced in detail in conjunction with the accompanying drawings.

Referring to FIG. 2, FIG. 2 is a flowchart of a method for reporting a maximum duration of a joint channel estimation provided by an example of the disclosure. It needs to be noted that the method for reporting the maximum duration of the joint channel estimation of the example of the disclosure may be applied to a terminal device. As shown in FIG. 2, the method for reporting the maximum duration of the joint channel estimation may include, but is not limited to, the steps S201 and S202.

Step S201, a first message sent by a network side device is received, where the first message is used for instructing the terminal device to report the maximum duration of the joint channel estimation.

In some embodiments according to the disclosure, the terminal device receives the first message sent by the network side device to report the maximum duration of the joint channel estimation, and the maximum duration may be understood as a reference value of the time window for the joint channel estimation of the terminal. As an example, the maximum duration may be preset, e.g. preset in the terminal device. Optionally, the maximum duration may be preset by the terminal device based on the own ability of the terminal device so that the terminal device sends the preset maximum duration to the network side device when receiving the first message sent by the network side device. In addition, it is to be understood that the maximum duration may be determined in other fashions, e.g., configured by the network side device or agreed on according to a protocol, etc.

In some examples of the disclosure, the first message may be sent by the network side device via a broadcast channel, or the first message may be sent via radio resource control (RRC) signaling.

By way of example, when the terminal device and the network side device perform a joint channel estimation, the network side device may send the first message to the terminal device via the broadcast channel or the RRC signaling. The first message is used for instructing the terminal device to report the maximum duration of the joint channel estimation so that the terminal device reports the maximum duration of the joint channel estimation to the network side device after receiving the first message sent by the network side device. It is to be understood that one maximum duration may be preset in the terminal device, or a plurality of maximum durations may be preset.

Step S202, the maximum duration is sent to the network side device.

After receiving the first message sent by the network side device, the terminal device sends the maximum duration of the joint channel estimation that it can support to the network side device. The network side device may configure a length of the time window of the joint channel estimation for the terminal device based on the maximum duration of the joint channel estimation reported by the terminal device, so that the terminal device maintains power consistency and phase continuity during the time window so as to cooperate with the network side device to execute joint channel estimation in the time window.

By implementing the example of the disclosure, the terminal device reports the maximum duration of the joint channel estimation, so as to enable the network side device to take the maximum duration as the reference value of the time window for the joint channel estimation of the terminal, and configure the length of the time window for a retransmission of the joint channel estimation for the terminal device based on the reference value. Thus, being able to improve uplink channel estimation performance of a communication system, as well as the uplink coverage.

It needs to be noted that in some examples of the disclosure, the network side device may indicate its own demodulation ability to the terminal device so as to enable the terminal device to report the maximum duration of the joint channel estimation based on its own ability and the demodulation ability of the network side device. See FIG. 3 for details.

FIG. 3 is a flowchart of another method for reporting a maximum duration of a joint channel estimation provided by an example of the disclosure. It needs to be noted that the method for reporting the maximum duration of the joint channel estimation of the example of the disclosure may be applied to a terminal device. As shown in FIG. 3, the method for reporting the maximum duration of the joint channel estimation may include, but is not limited to, the steps S301 and S302.

Step S301, a first message sent by a network side device is received. The first message is used for instructing the terminal device to report the maximum duration of the joint channel estimation, and the first message is further used for indicating a demodulation ability of the network side device to the terminal device.

In some embodiments according to the disclosure, the terminal device receives the first message sent by the network side device. The first message includes information of the demodulation ability of the network side device, and further instructs the terminal device to report the maximum duration of the joint channel estimation. The maximum duration may be understood as a reference value of the time window for the joint channel estimation of the terminal. As an example, the maximum duration may be preset, e.g. preset in the terminal device. For example, the maximum duration may be preset for the terminal device based on the own ability of the terminal device, so that when the terminal device receives the first message sent by the network side device, the terminal device may send the preset maximum duration to the network side device based on the demodulation ability of the network side device. It is to be understood that one maximum duration may be preset in the terminal device, or a plurality of maximum durations may be preset.

It needs to be noted that in some examples of the disclosure, the first message may be sent by the network side device via a broadcast channel, or may be sent via RRC signaling.

By way of example, when the terminal device and the network side device perform a joint channel estimation, the network side device may send the first message to the terminal device via the broadcast channel or the RRC signaling. The first message is used for instructing the terminal device to report the maximum duration of the joint channel estimation so that the terminal device reports the maximum duration of the joint channel estimation to the network side device in accordance with the demodulation ability of the network side device after receiving the first message sent by the network side device.

Step S302, the maximum duration corresponding to the demodulation ability is sent to the network side device in accordance with the demodulation ability of the network side device.

By way of example, the demodulation ability of the network side device may be divided into a plurality of different levels, and the network side device may inform the terminal device of the demodulation ability that can be supported by the network side device at present via the first message. After receiving the first message sent by the network side device, the terminal device may determine a specific demodulation ability level of the network side device and, in accordance with the demodulation ability level of the network side device, send the maximum duration of the joint channel estimation corresponding to the demodulation ability level.

As an example, the demodulation ability of the network side device is divided into two levels, a high level and a low level, may be taken as an example. A length of demodulation ability information of the network side device may be 1 bit. It is assumed that the maximum duration of the joint channel estimation corresponding to a network side device with a high level of demodulation ability is 16 slots, while the maximum duration of the joint channel estimation corresponding to a network side device with a low level of demodulation ability is 8 slots. The maximum durations that can be supported by the terminal device are 8 slots and 16 slots. If the terminal device receives the first message sent by the network side device and the first message indicates that the demodulation ability of the network side device is the high level, the maximum duration that the terminal device sends to the network side device is 16 slots. If the terminal device receives the message sent by the network side device and the first message indicates that the demodulation ability of the network side device is the low level, the maximum duration that the terminal device sends to the network side device is 8 slots.

As another example, if the terminal device can support merely one maximum duration, the terminal device may directly report the maximum duration that it supports without the need to select the maximum duration to be sent to the network side device that is corresponding to the demodulation ability of the network side device in accordance with the obtained demodulation ability information of the network side device. That is, if the terminal device can support merely one maximum duration, in response to receiving an instruction message sent by the network side device requesting the maximum duration to be reported, the terminal device directly reports the maximum duration that it can support.

By implementing the example of the disclosure, the terminal device reports the maximum duration corresponding to the demodulation ability to the network side device based on the own demodulation ability of the network side device, so as to enable the network side device to configure the length of the time window for a retransmission of the joint channel estimation for the terminal device based on the maximum duration, so that the time window configured for the terminal device by the network side device takes into account not only the own ability of the terminal device, but also the own demodulation ability of the network side device, which can simultaneously bring out the overall performance of the terminal and the system. Thus, being able to improve the performance of the uplink channel estimation of the communication system, as well as the uplink coverage.

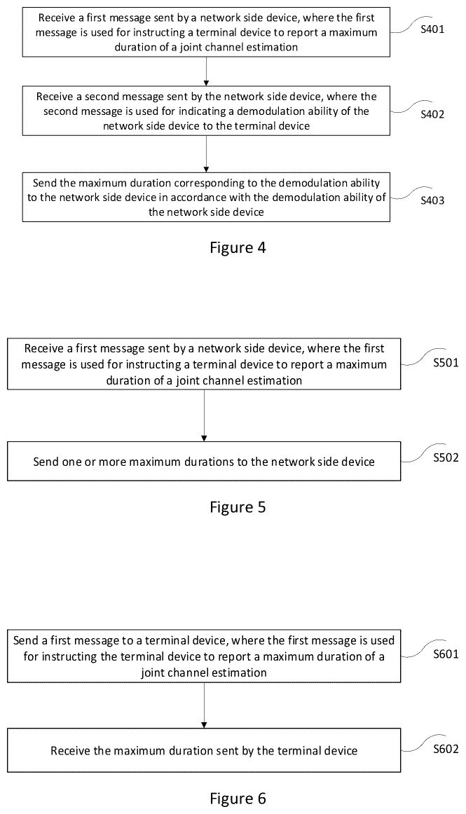

In some examples of the disclosure, the terminal device may further receive a second message sent by the network side device, and the second message is used for indicating the demodulation ability of the network side device to terminal device. That is, the terminal device receives the first message and the second message sent by the network side device, where the first message is used for instructing the terminal device to report the maximum duration of the joint channel estimation, and the second message is used for indicating the demodulation ability of the network side device to terminal device. Please refer to FIG. 4. FIG. 4 is a flowchart of another method for reporting a maximum duration of the joint channel estimation provided by an example of the disclosure. The method for reporting the maximum duration of the joint channel estimation of the example of the disclosure may be applied to a terminal device. As shown in FIG. 4, the method for reporting the maximum duration of the joint channel estimation may include, but is not limited to, the steps S401-S403.

Step S401, a first message sent by a network side device is received, and the first message is used for instructing the terminal device to report the maximum duration of the joint channel estimation.

In the example of the disclosure, step S401 may be implemented by adopting any fashion according to the various examples of the disclosure, which is not limited by the example of the disclosure and will not be repeated.

Step S402, a second message sent by the network side device is received. The second message is used for indicating a demodulation ability of the network side device to the terminal device.

In some embodiments according to the disclosure, the terminal device may further receive a second message sent by the network side device, and the second message may be different from the first message and contains demodulation ability information of the network side device. However, it is to be understood that in some possible embodiments, the second message may be the same as the first message.

As an example, the second message may be RRC signaling. Or, the second message may further be sent by the network side device to the terminal device via a broadcast channel.

It needs to be noted that in the example of the disclosure, step S401 and step S402 may be performed simultaneously. Or step S401 may be performed first followed by step S402. Or step S402 may be performed first followed by step S401. Furthermore, it is to be understood that step S402 may be implemented in combination with step S401 or separately, which is not limited by the disclosure.

Step S403, the maximum duration corresponding to the demodulation ability is sent to the network side device in accordance with the demodulation ability of the network side device.

In the example of the disclosure, step S403 may be implemented by adopting any fashion according to the various examples of the disclosure, which is not limited by the example of the disclosure and will not be repeated.

It needs to be noted that in the example of the disclosure, step S401 may not be executed. That is, the terminal device may send the preset maximum duration to the network side device in response to receiving the second message sent by the network side device without waiting to receive the first message instructing the terminal device to report the maximum duration of joint channel estimation.

By implementing the example of the disclosure, the terminal device may obtain the demodulation ability of the network side device via the second message sent by the network side device and report the maximum duration corresponding to the demodulation ability so as to enable the network side device to configure a length of the time window for a retransmission of the joint channel estimation for the terminal device based on the maximum duration, so that the time window configured for the terminal device by the network side device takes into account not only the own ability of the terminal device, but also the own demodulation ability of the network side device, which can simultaneously bring out the overall performance of the terminal and the system. Thus, being able to improve the performance of the uplink channel estimation of the communication system, as well as the uplink coverage.

In some examples of the disclosure, rather than the network side device indicating its own demodulation ability to the terminal device, the terminal device uploads one or more maximum durations that the terminal device supports to the network side device, and the network side device selects one maximum duration based on its (the network side device's) own demodulation ability so as to configure the length of the time window of the joint channel estimation for the terminal device based on the selected maximum duration. Please refer to FIG. 5. FIG. 5 is a flowchart of another method for reporting a maximum duration of the joint channel estimation provided by an example of the disclosure. The method for reporting the maximum duration of the joint channel estimation of the example of the disclosure may be applied to a terminal device. The terminal device in the example of the disclosure may report one or more maximum durations it supports to the network side device in accordance with its own ability. As shown in FIG. 5, the method for reporting the maximum duration of the joint channel estimation may include, but is not limited to, the steps S501 and S502.

Step S501, a first message sent by a network side device is received, and the first message is used for instructing the terminal device to report the maximum duration of joint channel estimation.

In the example of the disclosure, step S501 may be implemented by adopting any fashion according to the various examples of the disclosure respectively, which is not limited by the example of the disclosure and will not be repeated.

Step S502, one or more maximum durations are sent to the network side device.

Optionally, when receiving the first message sent by the network side device, the terminal device may report the one or more maximum durations it supports to the network side device, so that the network side device selects one maximum duration based on its own demodulation ability to configure a length of the time window of the joint channel estimation for the terminal device. In an embodiment, the terminal device may report all of its own maximum durations to the network side device for selection by the network side device.

By way of example, if the terminal device can support merely one maximum duration of the joint channel estimation, the one maximum duration of the joint channel estimation is reported to the network side device after receiving the first message sent by the network side device so as to allow the network side device to configure the length of the time window of the joint channel estimation for the terminal device based on the maximum duration. Or, if the terminal device can support a plurality of maximum durations of joint channel estimation, the plurality of supported maximum durations are reported to the network side device after receiving the first message sent by the network side device so as to allow the network side device to select one of the plurality of maximum durations based on its own demodulation ability, and to configure the length of the time window of the joint channel estimation for the terminal device based on the selected maximum duration.

By implementing the example of the disclosure, the terminal device may send one or more maximum durations to the network side device so as to enable the network side device to select one from the maximum durations reported by the terminal device based on its own demodulation ability to configure the length of the time window for a retransmission of the joint channel estimation for the terminal device, so that the time window configured for the terminal device by the network side device takes into account not only the own ability of the terminal device, but also the own demodulation ability of the network side device, which accordingly can simultaneously bring out the overall performance of the terminal and the system. Thus, being able to improve the performance of the uplink channel estimation of the communication system, as well as the uplink coverage.

Referring to FIG. 6, FIG. 6 is a flowchart of a method for obtaining a maximum duration of a joint channel estimation provided by an example of the disclosure. It needs to be noted that the method for obtaining the maximum duration of joint channel estimation of the example of the disclosure may be applied to a network side device. As shown in FIG. 6, the method for obtaining the maximum duration of joint channel estimation may include, but is not limited to, the steps S601 and S602.

Step S601, a first message is sent to a terminal device. The first message is used for instructing the terminal device to report the maximum duration of joint channel estimation.

By way of example, when the network side device and the terminal device perform a joint channel estimation, the network side device may send the first message to the terminal device via a broadcast channel or RRC signaling. The first message is used for instructing the terminal device to report the maximum duration of joint channel estimation.

In some examples of the disclosure, the maximum duration may be understood as a reference value of the time window for the joint channel estimation of the terminal. As an example, the maximum duration may be preset, e.g. preset at the terminal device. For example, the maximum duration may be preset for the terminal device based on the own ability of the terminal device, so that when the terminal device receives the first message sent by the network side device, the terminal device may send the preset maximum duration to the network side device.

Step S602, the maximum duration sent by the terminal device is received.

In an optional embodiment, the method further includes: configuring a length of the time window of the joint channel estimation for the terminal device in accordance with the maximum duration.

By way of example, after receiving the maximum duration sent by the terminal device, the network side device may configure the length of the time window of the joint channel estimation for the terminal device based on the maximum duration of the joint channel estimation reported by the terminal device, so that the terminal device maintains power consistency and phase continuity during the time window so as to cooperate with the network side device to execute the joint channel estimation in the time window.

Optionally, the length of the time window may be less than or equal to the maximum duration.

By way of example, if the maximum duration of the joint channel estimation reported by the terminal device is 8 slots, the length of the time window of the joint channel estimation configured by the network side device for the terminal device in accordance with the maximum duration may be 8 slots, i.e., it is equal to the maximum duration. Or the length of the time window of the joint channel estimation configured for the terminal device by the network side device in accordance with the maximum duration may be 7 slots, i.e., it is less than the maximum duration.

By implementing the example of the disclosure, the network side device receives the maximum duration of the joint channel estimation reported by the terminal device, takes the maximum duration as a reference value of the time window for the joint channel estimation of the terminal device, and configures a length of the time window for a retransmission of the joint channel estimation for the terminal device based on the reference value. Thus, being able to improve the performance of the uplink channel estimation of the communication system, as well as the uplink coverage.

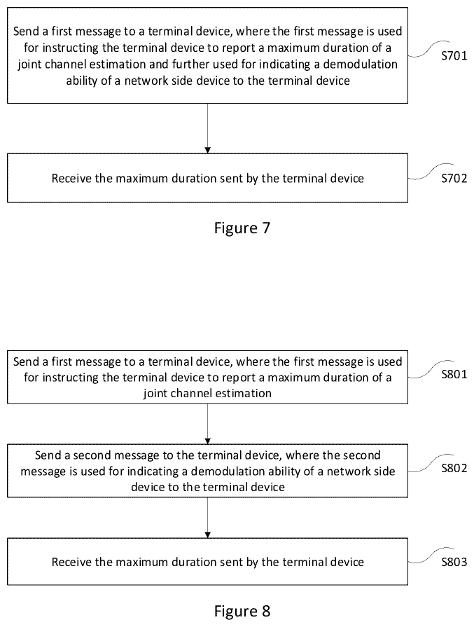

It needs to be noted that in some examples of the disclosure, the network side device may indicate its own demodulation ability to the terminal device so as to enable the terminal device to report the maximum duration of the joint channel estimation based on its own ability and the demodulation ability of the network side device. Please refer to FIG. 7. FIG. 7 is a flowchart of another method for obtaining a maximum duration of a joint channel estimation provided by an example of the disclosure. It needs to be noted that the method for obtaining the maximum duration of the joint channel estimation of the example of the disclosure may be applied to a network side device. As shown in FIG. 7, the method for obtaining the maximum duration of the joint channel estimation may include, but is not limited to, the steps S701 and S702.

Step S701, a first message is sent to a terminal device; the first message is used for instructing the terminal device to report the maximum duration of the joint channel estimation and further used for indicating a demodulation ability of the network side device to the terminal device.

It needs to be noted that in some examples of the disclosure, the first message may be sent by the network side device via a broadcast channel, or may be sent via RRC signaling.

By way of example, when the network side device and the terminal device perform the joint channel estimation, the network side device may send the first message to the terminal device via the broadcast channel or the RRC signaling. The first message is used for instructing the terminal device to report the maximum duration of joint channel estimation and indicating the demodulation ability of the network side device, so that the terminal device reports the maximum duration corresponding to the demodulation ability to the network side device in accordance with the demodulation ability of the network side device after receiving the first message sent by the network side device.

Step S702, the maximum duration sent by the terminal device is received.

In the example of the disclosure, step S702 may be implemented by adopting any fashion according to the various examples of the disclosure, which is not limited by the example of the disclosure and will not be repeated.

Optionally, in some examples according to the disclosure, the method for obtaining the maximum duration of the joint channel estimation may further include the following steps: configuring a length of the time window of the joint channel estimation for the terminal device in accordance with the maximum duration reported by the terminal device. The length of the time window may be less than or equal to the maximum duration.

By implementing the example of the disclosure, the network side device may indicate its own demodulation ability to the terminal device, receives the maximum duration corresponding to the demodulation ability reported by the terminal device, takes the maximum duration as a reference value of the time window for the joint channel estimation of the terminal device, and configures a length of the time window for a retransmission of the joint channel estimation for the terminal device based on the reference value. Thus, being able to improve the performance of the uplink channel estimation of the communication system, as well as the uplink coverage.

In some examples of the disclosure, the network side device may further indicate the demodulation ability of the network side device to the terminal device by sending a second message to the terminal device so as to enable the terminal device to report the maximum duration of the joint channel estimation based on the demodulation ability of the network side device. Please refer to FIG. 8. FIG. 8 is a flowchart of yet another method for obtaining a maximum duration of a joint channel estimation provided by an example of the disclosure. It needs to be noted that the method for obtaining the maximum duration of the joint channel estimation of the example of the disclosure may be applied to a network side device. As shown in FIG. 8, the method for obtaining the maximum duration of the joint channel estimation may include, but is not limited to, the steps S801-S803.

Step S801, a first message is sent to a terminal device; the first message being used for instructing the terminal device to report the maximum duration of the joint channel estimation.

In the example of the disclosure, step S801 may be implemented by adopting any fashion according to the various examples of the disclosure, which is not limited by the example of the disclosure and will not be repeated.

Step S802, a second message is sent to the terminal device. The second message is used for indicating a demodulation ability of the network side device to the terminal device.

By way of example, the terminal device may further receive the second message sent by the network side device, and the second message is different from the first message and contains the demodulation ability information of the network side device.

As an example, the second message may be RRC signaling. Or, the second message may further be sent by the network side device to the terminal device via a broadcast channel.

It needs to be noted that in the example of the disclosure, step S801 and step S802 may be performed simultaneously. Or step S801 may be performed first followed by step S802. Or step S802 may be performed first followed by step S801.

Step S803, the maximum duration sent by the terminal device is received.

In the example of the disclosure, step S803 may be implemented by adopting any fashion according to the various examples of the disclosure, which is not limited by the example of the disclosure and will not be repeated.

Optionally, in some examples according to the disclosure, the method for obtaining the maximum duration of the joint channel estimation may further include the following steps: configuring a length of the time window of the joint channel estimation for the terminal device in accordance with the maximum duration reported by the terminal device. The length of the time window may be less than or equal to the maximum duration.

By implementing the example of the disclosure, the network side device may indicate its own demodulation ability to the terminal device via the second message so as to enable the terminal device to report the maximum duration corresponding to the demodulation ability, receives the maximum duration corresponding to the demodulation ability reported by the terminal device, takes the maximum duration as a reference value of the time window for the joint channel estimation of the terminal device, and configures a length of the time window for a retransmission of the joint channel estimation for the terminal device based on the reference value. Thus, being able to improve the performance of the uplink channel estimation of the communication system, as well as the uplink coverage.

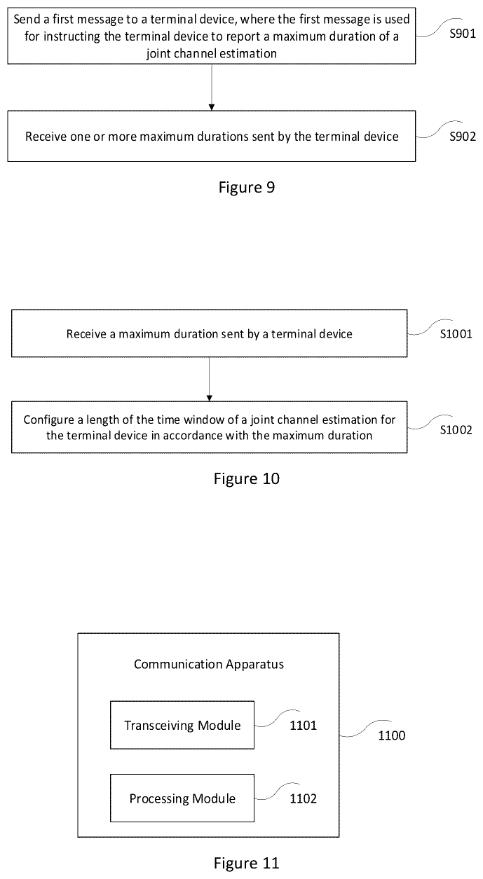

In some examples of the disclosure, the network side device may receive one or more maximum durations sent by the terminal device, and selects one maximum duration based on its own demodulation ability to configure the length of the time window of the joint channel estimation for the terminal device based on the selected maximum duration. Please refer to FIG. 9. FIG. 9 is a flowchart of yet another method for obtaining a maximum duration of a joint channel estimation provided by an example of the disclosure. It needs to be noted that the method for obtaining the maximum duration of the joint channel estimation of the example of the disclosure may be applied to a network side device. As shown in FIG. 9, the method for obtaining the maximum duration of the joint channel estimation may include, but is not limited to, the steps S901 and S902.

Step S901, a first message is sent to a terminal device. The first message is used for instructing the terminal device to report the maximum duration of joint channel estimation.

Optionally, when receiving the first message sent by the network side device, the terminal device may report one or more maximum durations it supports to the network side device for selection by the network side device.

Step S902, the one or more maximum durations sent by the terminal device are received.

It needs be noted that in some examples of the disclosure, when receiving one or more maximum durations sent by the terminal device, the network side device may configure the length of the time window of the joint channel estimation for the terminal device based on the one or more maximum durations. In an embodiment, when receiving one maximum duration sent by the terminal device, the network side device may configure the length of the time window of the joint channel estimation for the terminal device based on the maximum duration. Or, when receiving the plurality of maximum durations sent by the terminal device, the network side device may select one maximum duration from the plurality of maximum durations in accordance with a demodulation ability of the network side device, and configure a length of the time window of the joint channel estimation for the terminal device based on the selected maximum duration. The length of the time window may be less than or equal to the maximum duration for configuring the time window.

By way of example, when the network side device receives one maximum duration sent by the terminal device and configures the length of the time window of the joint channel estimation for the terminal device based on the maximum duration, the length of the time window may be less than or equal to the maximum duration. Or, when the network side device receives the plurality of maximum durations sent by the terminal device and selects one maximum duration based on its own demodulation ability to configure the length of the time window of the joint channel estimation for the terminal device, the length of the time window may be less than or equal to the selected maximum duration.

As an example, assuming that the terminal device sends merely one maximum duration of 8 slots, the network side device may configure a length of the time window of the joint channel estimation for the terminal device in accordance with the maximum duration. Or, two maximum durations sent simultaneously by the terminal device are 8 slots and 16 slots. If the demodulation ability of the network side device is higher, 16 slots may be selected as the reference value of the time window for the joint channel estimation of the terminal, and the length of the time window of the joint channel estimation is configured for the terminal device based on 16 slots. Or, if the demodulation ability of the network side device is lower, 8 slots may be selected as the reference value of the time window for the joint channel estimation of the terminal, and the length of the time window of the joint channel estimation is configured for the terminal device based on 8 slots.

By implementing the example of the disclosure, the one or more maximum durations sent by the terminal device are received, thus the network side device selects one from the maximum durations reported by the terminal device based on its own demodulation ability to configure the length of the time window for a retransmission of the joint channel estimation for the terminal device, so that the time window configured for the terminal device by the network side device takes into account not only the own demodulation ability of the network side device, but also the ability of the terminal device, which can simultaneously bring out the overall performance of the terminal and the system. Thus, being able to improve the performance of the uplink channel estimation of the communication system, as well as the uplink coverage.

In some examples of the disclosure, the network side device may receive the maximum duration sent by the terminal device and configure the length of the time window of the joint channel estimation for the terminal device based on the maximum duration. See FIG. 10 for details. FIG. 10 is a flowchart of yet another method for obtaining a maximum duration of a joint channel estimation provided by an example of the disclosure; It needs to be noted that the method for obtaining the maximum duration of the joint channel estimation of the example of the disclosure may be applied to a network side device. As shown in FIG. 10, the method for obtaining the maximum duration of the joint channel estimation may include, but is not limited to, the steps S1001 and S1002.

Step S1001, the maximum duration sent by a terminal device is received.

In the example of the disclosure, the maximum duration may be actively sent by the terminal device. Or, the maximum duration may be sent by the terminal device in response to receiving a first message sent by the network side device. The first message is used for instructing the terminal device to report the maximum duration of the joint channel estimation. Or, the maximum duration may also be sent by the terminal device in response to receiving a first message and a second message sent by the network side device, the first message is used for instructing the terminal device to report the maximum duration of the joint channel estimation, and the second message is used for indicating a demodulation ability of the network side device. However, it is to be understood that in some possible embodiments, the second message may be the same as the first message.

By way of example, the network side device may not send any message and instead directly receive the maximum duration sent by the terminal device.

For example, the network side device may send a first message to the terminal device, and the first message is used for instructing the terminal device to report the maximum duration of the joint channel estimation. The terminal device receives the first message sent by the network side device to report the maximum duration of the joint channel estimation, and the maximum duration may be understood as a reference value of the time window for the joint channel estimation of the terminal. As an example, the maximum duration may be preset, e.g. preset in the terminal device. Optionally, the maximum duration may be preset by the terminal device based on the own ability of the terminal device so that the terminal device sends the preset maximum duration to the network side device when receiving the first message sent by the network side device. In addition, it is to be understood that the maximum duration may be determined in other fashions, e.g., configured by the network side device or agreed on according to a protocol, etc.

For another example, the network side device may send a first message to the terminal device, and the first message is used for instructing the terminal device to report the maximum duration of the joint channel estimation, and further used for indicating a demodulation ability of the network side device. Optionally, the terminal device receives the first message sent by the network side device and reports the maximum duration corresponding to the demodulation ability of the network side device to the network side device, so that the network side device may receive the maximum duration reported by the terminal device.

For example, again, the network side device may send a first message and a second message to the terminal device, the first message is used for instructing the terminal device to report the maximum duration of the joint channel estimation, and the second message is used for indicating the demodulation ability of the network side device. Optionally, the terminal device receives the first message and the second message sent by the network side device and reports the maximum duration corresponding to the demodulation ability of the network side device to the network side device, so that the network side device may receive the maximum duration reported by the terminal device.

It needs be noted that in the example of the disclosure, one or more maximum durations may be sent by the terminal device.

Step S1002, a length of the time window of the joint channel estimation is configured for the terminal device in accordance with the maximum duration.

As an example, if the network side device receives one maximum duration sent by the terminal device, the network side device may configure the length of the time window of the joint channel estimation for the terminal device based on the maximum duration of the joint channel estimation reported by the terminal device, so that the terminal device maintains power consistency and phase continuity during the time window so as to cooperate with the network side device to execute the joint channel estimation in the time window.

As another example, if the network side device receives a plurality of maximum durations sent by the terminal device, the network side device may select one from the plurality of maximum durations based on its own demodulation ability, and configure a length of the time window of the joint channel estimation for the terminal device based on the selected maximum duration, so that the terminal device maintains power consistency and phase continuity during the time window so as to cooperate with the network side device to execute the joint channel estimation in the time window.

By implementing the example of the disclosure, the network side device may configure the time window of the joint channel estimation for the terminal device based on the received maximum duration sent by the terminal device and taking into account the own demodulation ability of the network side device, thus being able to improve the performance of the uplink channel estimation of the communication system, as well as the uplink coverage. In the examples provided in the disclosure, the methods provided in the examples of the disclosure are described from the perspectives of the terminal device and the network side device respectively. In order to implement the functions in the methods provided by the examples of the disclosure, the terminal device and the network side device may include a hardware structure and a software module to implement the functions in the form of the hardware structure, the software module, or a hardware structure plus a software module. A certain function of the functions may be executed in the form of the hardware structure, the software module or the hardware structure plus the software module.

Please refer to FIG. 11 which is a schematic structural diagram of a communication apparatus 1100 provided by an example of the disclosure. The communication apparatus 1100 shown in FIG. 11 may include a transceiving module 1101 and a processing module 1102. The transceiving module 1101 may include a sending module and/or a receiving module, such as an input/output device, the sending module is configured to implement a sending function, the receiving module is configured to implement a receiving function, and the transceiving module 1101 may implement the sending function and/or the receiving function.

The communication apparatus 1100 may be a terminal device, or an apparatus in the terminal device, or an apparatus used in conjunction with the terminal device. Or, the communication apparatus 1100 may be a network side device, or an apparatus in the network side device, or an apparatus used in conjunction with the network side device.

When the communication apparatus 1100 is a terminal device: the transceiving module 1101 is configured to receive a first message sent by a network side device. The first message is used for instructing the terminal device to report a maximum duration of a joint channel estimation. The transceiving module 1101 is further configured to send the maximum duration to the network side device.

In an embodiment, the first message is further used for indicating a demodulation ability of the network side device to the terminal device.

In an embodiment, the transceiving module 1101 is specifically configured to receive a second message sent by the network side device, and the second message is used for indicating the demodulation ability of the network side device to the terminal device.

In an optional embodiment, the transceiving module is 1101 is specifically configured to send the maximum duration corresponding to the demodulation ability to the network side device in accordance with the demodulation ability of the network side device.

In an embodiment, the transceiving module 1101 is specifically configured to send one or more maximum durations to the network side device.

As an example, the processing module 1102 may be a processor, the transceiving module 1101 may be a transceiver or a communication interface, and the storage module may be a memory.

When the communication apparatus 1100 is a network side device: the transceiving module 1101 is configured to send a first message to a terminal device. The first message is used for instructing the terminal device to report a maximum duration of a joint channel estimation. The transceiving module 1101 is further configured to receive the maximum duration sent by the terminal device.

In an embodiment, the first message is further used for indicating a demodulation ability of the network side device to the terminal device.

In an embodiment, the transceiving module 1101 is specifically configured to send a second message to the terminal device, and the second message is used for indicating the demodulation ability of the network side device to the terminal device.

In an optional embodiment, the processing module 1102 is configured to configure a length of the time window of the joint channel estimation for the terminal device in accordance with the maximum duration.

Optionally, the length of the time window is less than or equal to the maximum duration.

In an embodiment, the transceiving module 1101 is specifically configured to receive one or more maximum durations sent by the terminal device.

In an optional embodiment, the transceiving module 1101 is specifically configured to: configure a length of the time window of the joint channel estimation for the terminal device in accordance with one maximum duration in response to determining of receiving the one maximum duration sent by the terminal device; or select one maximum duration from the plurality of maximum durations in accordance with the demodulation ability of the network side device in response to receiving the plurality of maximum durations sent by the terminal device, and configure a length of the time window of the joint channel estimation for the terminal device in accordance with the selected maximum duration.

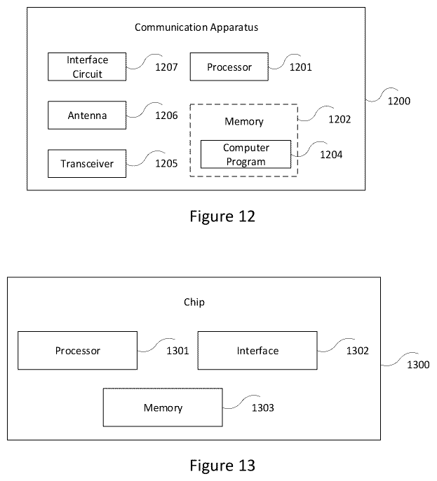

Please refer to FIG. 12. FIG. 12 is a schematic structural diagram of another communication apparatus 1200 provided by an example of the disclosure. The communication apparatus 1200 may be a communication apparatus, and may also be a chip, a chip system, or a processor, etc., that supports the communication apparatus in implementing any of the methods. The communication apparatus may be used for implementing the methods described in the method examples, the details of which are described herein.

The communication apparatus 1200 may include one or more processors 1201. The processor 1201 may be a general-purpose processor or a specialized processor, etc. It may be, for example, a baseband processor or a central processing unit. The baseband processor may be used for processing a communication protocol and communication data, and the central processing unit may be used for controlling a communication apparatus (e.g., a base station, a baseband chip, an electronic device, an electronic device chip, a DU or a CU, etc.), executing a computer program, and processing data from the computer program.

One or more memories 1202 may also be included in the communication apparatus 1200 on which a computer program 1204 may be stored, and the processor 1201 executes the computer program 1204 to enable the communication apparatus 1200 to execute the methods described in the method examples. Optionally, data may also be stored in the memory 1202. The communication apparatus 1200 and the memory 1202 may be arranged separately or may be integrated together.

The communication apparatus 1200 may also include a transceiver 1205, and an antenna 1206. The transceiver 1205 may be referred to as a transceiving unit, a transceiver, or a transceiving circuit, etc., and is used for implementing a transceiving function. The transceiver 1205 may include a receiver and a sender, the receiver may be referred to as a receiving machine or receiving circuit, etc., for implementing a receiving function, and the sender may be referred to as a sending machine or sending circuit, etc., for implementing a sending function.

One or more interface circuits 1207 may also be included in the communication apparatus 1200. The interface circuit 1207 is used for receiving a code instruction and transmitting it to the processor 1201. The processor 1201 runs the code instruction so as to enable the communication apparatus 1200 to execute any of the methods described in the method examples.

When the communication apparatus 1200 is the terminal device in the foregoing method examples: the transceiver 1205 is used for executing step S201 and step S202 in FIG. 2, step S301 and step S302 in FIG. 3, step S401, step S402 and step S403 in FIG. 4, and steps S501 and S502 in FIG. 5.

When the communication apparatus 1200 is the network side device in the foregoing method examples: the transceiver 1205 is used for executing steps S601 and step S602 in FIG. 6, steps S701 and step S702 in FIG. 7, step S801, step S802, and step S803 in FIG. 8, step S901 and step S902 in FIG. 9, and step S1001 and step S1002 in FIG. 10.

In an embodiment, the processor 1201 may include a transceiver for implementing receiving and sending functions. For example, the transceiver may be a transceiving circuit, or an interface, or an interface circuit. The transceiving circuit, interface, or interface circuit used for implementing the receiving and sending functions may be separate or integrated together. The transceiving circuit, interface, or interface circuit may be used for reading and writing of a code/data, or may be used for transmitting or transferring of a signal.

In an embodiment, the processor 1201 may store a computer program (not shown), and the computer program run on the processor 1201 may enable the communication apparatus 1201 to execute the methods described in the method examples. The computer program may be solidified in the processor 1201, in which case the processor 1201 may be implemented by hardware. The computer program stored by the processor may be a computer program different from the computer program 1204 stored in the memory 1202.

In an embodiment, the communication apparatus 1201 may include a circuit, and the circuit may implement the function of sending or receiving or communicating in the method examples. The processor (1102, 1201, or 1301) and transceiver (1101, 1205, or 1302) described in the disclosure may be implemented on an integrated circuit (IC), an analog IC, a radio frequency integrated circuit (RFIC), a mixed signal IC, an application specific integrated circuit (ASIC), a printed circuit board (PCB), an electronic device, and the like. The processor and transceiver may also be manufactured by using a variety of IC process technologies, such as a complementary metal oxide semiconductor (CMOS), and an nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus in the description of the examples may be a network side device or a terminal device, but the scope of the communication apparatus described in the disclosure is not limited to this, and the structure of the communication apparatus may not be limited by FIG. 12. The communication apparatus may be a separate device or may be part of a larger device. For example, the communication apparatus may be: (1) a separate integrated circuit (IC), or a chip, or, a chip system or subsystem; (2) a set having one or more ICs, where optionally, the set of ICs may also include a storage component for storing data and a computer program; (3) an ASIC, such as a modem; (4) a module that may be embedded within other devices; (5) a receiver, a terminal device, an intelligent terminal device, a cellular phone, a wireless device, a handset, a mobile unit, an in-vehicle device, a network side device, a cloud device, an artificial intelligence device, etc; and (6) other, etc.

For the case where the communication apparatus may be a chip or a chip system, please refer to a schematic structural diagram of a chip shown in FIG. 13. The chip 1300 shown in FIG. 13 includes a processor 1301, an interface 1302, and a memory 1303. One or more processors 1301 may be arranged, and a plurality of interfaces 1302 may be arranged.

For a case where the chip 1300 is used for implementing the functions of the terminal device in the examples of the disclosure: an interface 1302 is used for receiving a first message sent by a network side device and the first message is used for instructing the terminal device to report a maximum duration of joint channel estimation. The interface 1302 is further used for sending the maximum duration to the network side device.

In an embodiment, the first message is further used for indicating a demodulation ability of the network side device to the terminal device.

In an embodiment, the interface 1302 is specifically used for receiving a second message sent by the network side device, and the second message is used for indicating the demodulation ability of the network side device to the terminal device.

In an optional embodiment, the interface 1302 is specifically used for sending the maximum duration corresponding to the demodulation ability to the network side device in accordance with the demodulation ability of the network side device.

In an embodiment, the interface 1302 is specifically used for sending one or more maximum durations to the network side device.

For a case where the chip 1300 is used for implementing the functions of the network side device in the examples of the disclosure the interface 1302 is used for sending a first message to the terminal device. The first message is used for instructing the terminal device to report a maximum duration of joint channel estimation. The transceiver module is further configured to receive the maximum duration sent by the terminal device.

In an embodiment, the first message is further used for indicating a demodulation ability of the network side device to the terminal device.

In an embodiment, the interface 1302 is specifically used for sending a second message to the terminal device, and the second message is used for indicating the demodulation ability of the network side device to the terminal device.

In an optional embodiment, the interface 1302 is further used for configuring a length of the time window of joint channel estimation for the terminal device in accordance with the maximum duration.

Optionally, the length of the time window is less than or equal to the maximum duration.

In an embodiment, the interface 1302 is specifically used for receiving one or more maximum durations sent by the terminal device.

In an optional embodiment, the processor 1301 is specifically used for: configuring a length of the time window of joint channel estimation for the terminal device in accordance with one maximum duration when the interface 1302 receives the one maximum duration sent by the terminal device; or selecting one maximum duration from the plurality of maximum durations in accordance with the demodulation ability of the network side device when the interface 1302 receives the plurality of maximum durations sent by the terminal device, and configuring a length of the time window of joint channel estimation for the terminal device in accordance with the selected maximum duration.

The chip further includes a memory 1303, and the memory 1303 is used for storing necessary computer programs and data.

Those skilled in the art may further appreciate that various illustrative logical blocks and steps set forth in the examples of the disclosure may be implemented by electronic hardware, computer software, or a combination of the two. Whether such a function is implemented by hardware or software depends on a specific application and design requirements of an overall system. Those skilled in the art may, for each specific application, use various methods to implement the described function, but such embodiment is not to be construed as being outside the scope of protection of the examples of the disclosure.

An example of the disclosure further provides a system for reporting a maximum duration of joint channel estimation, the system includes a communication apparatus as a terminal device and a communication apparatus as a network side device in the example of FIG. 8, or, the system includes a communication apparatus as a terminal device and a communication apparatus as a network side device in the example of FIG. 9.

The disclosure further provides a non-transitory computer-readable storage medium on which an instruction is stored. When executed by a computer, the instruction implements the function of any one of the method examples.

The disclosure further provides a computer program product. When executed by a computer, the computer program product implements the function of any one of the method examples.

In the examples, the function may be implemented in whole or in part by software, hardware, firmware, or any combination of them. When implemented by using software, the function may be implemented in whole or in part in the form of the computer program product. The computer program product includes one or more computer programs. When the computer program is loaded and executed on a computer, the process or function described according to the examples of the disclosure is generated in whole or in part. The computer may be a general-purpose computer, a specialized computer, a computer network, or other programmable apparatuses. The computer program may be stored in a non-transitory computer readable storage medium or transmitted from one computer readable storage medium to another computer readable storage medium. For example, the computer program may be transmitted from one website, computer, server, or data center to another website, computer, server, or data center by wired (e.g., a coaxial cable, optical fiber, and digital subscriber line (DSL)) or wireless (e.g., infrared, wireless, microwave, etc.) means. The non-transitory computer readable storage medium may be any available medium to which a computer can access or a data storage device such as a server, data center, etc., that contains one or more available medium integrations. The available medium may be a magnetic medium (e.g., a floppy disk, a hard disk, and a tape), an optical medium (e.g., a high-density digital video disc (DVD)), or a semiconductor medium (e.g., a solid-state disk (SSD)), etc.

Those ordinarily skilled in the art may understand that first, second, and various other numerical numbers involved in the disclosure are merely distinguished for descriptive convenience, are not used for limiting the scope of the examples of the disclosure, and also indicate the order of precedence.

At least one in the disclosure may also be described as one or more, and a plurality may be two, three, four, or more, without limitation of the disclosure. In the examples of the disclosure, for a technical feature, technical features in the technical feature are distinguished by “first”, “second”, “third”, “A”, “B”, “C”, “D”, etc. There is no order of precedence or magnitude among the technical features described in “first”, “second”, “third”, “A”, “B”, “C” and “D”.

Correspondences shown in tables in the disclosure may be configured or may be predefined. Values of information in the tables are merely examples and may be configured to other values, which is not limited by the disclosure. When a correspondence between information and each parameter is configured, it is not necessarily required that all correspondences illustrated in each table must be configured. For example, the correspondence illustrated in certain rows of the tables in the disclosure may also be unconfigured. For another example, appropriate distortion adjustments may be made based on the above table, e.g., splitting, merging, etc. Names of parameters shown in headings in the above tables may also be other names understandable by the communication apparatus, and values or representations of the parameters of which may also be other values or representations understandable by the communication apparatus. Each of the above tables may also be implemented with other data structures. For example, an array, a queue, a container, a stack, a linear table, a pointer, a chained table, a tree, a graph, a structure, a class, a heap, a hash table, or a hash table, etc. may be used.

Predefining in the disclosure may be understood as defining, defining in advance, storing, pre-storing, pre-negotiating, pre-configuring, curing, or pre-firing.

Those ordinarily skilled in the art may realize that units and algorithmic steps of the various examples described in conjunction with the examples disclosed here can be implemented with electronic hardware, or a combination of computer software and electronic hardware. Whether these functions are performed in a form of hardware or software depends on the specific application and design constraints of the technical solutions. Those skilled in the art may use different methods to implement the described functions for each specific application, but such embodiment is not considered to be beyond the scope of the disclosure.

It is clearly understood by those skilled in the art to which it belongs that, for the convenience and brevity of the description, the specific work processes of the systems, apparatuses, and units described herein may refer to the corresponding processes in the method examples, which will not be repeated here.

The provided examples are merely specific embodiments of the disclosure, but the scope of protection of the disclosure is not limited to this. Changes or replacements that can be easily thought of by those skilled in art within the technical scope disclosed in the disclosure are to be covered in the scope of protection of the disclosure. Thus, the scope of protection of the disclosure is to be subject to the scope of protection of the claims.

1. A method for reporting a maximum duration of a joint channel estimation, executed by a terminal device, comprising:
receiving a first message sent by a network side device, wherein the first message instructs the terminal device to report the maximum duration of the joint channel estimation; and
sending the maximum duration to the network side device.

2. The method according to claim 1, wherein the first message further indicates a demodulation ability of the network side device.

3. The method according to claim 1, further comprising:
receiving a second message sent by the network side device, wherein the second message indicates a demodulation ability of the network side device.

4. The method according to claim 2, wherein sending the maximum duration to the network side device comprises:
sending the maximum duration corresponding to the demodulation ability to the network side device in accordance with the demodulation ability of the network side device.

5. The method according to claim 1, wherein sending the maximum duration to the network side device comprises:
sending one or more maximum durations to the network side device.

6. A method for obtaining a maximum duration of a joint channel estimation, executed by a network side device, comprising:
sending a first message to a terminal device, wherein the first message instructs the terminal device to report the maximum duration of the joint channel estimation; and
receiving the maximum duration sent by the terminal device.

7. The method according to claim 6, wherein the first message further indicates a demodulation ability of the network side device.

8. The method according to claim 6, further comprising:
sending a second message to the terminal device, wherein the second message indicates a demodulation ability of the network side device.

9. The method according to claim 8, further comprising:
configuring a length of a time window of the joint channel estimation for the terminal device in accordance with the maximum duration.

10. The method according to claim 9, wherein the length of the time window is less than or equal to the maximum duration.

11. The method according to claim 6, wherein receiving the maximum duration sent by the terminal device comprises:
receiving one or more maximum durations sent by the terminal device.

12. The method according to claim 11, further comprising:
configuring a length of a time window of the joint channel estimation for the terminal device in accordance with the one or more maximum durations in response to receiving the one or more maximum durations sent by the terminal device.

13. A communication apparatus, comprising:
a transceiving module receives a first message sent by a network side device, wherein the first message instructs a terminal device to report a maximum duration of a joint channel estimation; and
the transceiving module sends the maximum duration to the network side device.

14. A communication apparatus, comprising:
a transceiving module executes the method according to claim 6.

15. A communication apparatus, comprising a processor and a memory, wherein a computer program is stored in the memory, and the processor executes the computer program to enable the terminal device to execute the method according to claim 1.

16. A communication apparatus, comprising a processor and a memory, wherein a computer program is stored in the memory, and the processor executes the computer program to enable the terminal device to execute the method according to claim 6.

17. A non-transitory computer readable storage medium for storing an instruction, when executed by a processor causes the processor to perform the method according to claim 1.

18. A non-transitory computer readable storage medium for storing an instruction, when executed by a processor causes the processor to implement the method according to claim 6.

19. The method according to claim 3, wherein sending the maximum duration to the network side device comprises:
sending the maximum duration corresponding to the demodulation ability to the network side device in accordance with the demodulation ability of the network side device.

20. The method according to claim 11, further comprising:
selecting one maximum duration from the one or more maximum durations in accordance with the demodulation ability of the network side device in response to receiving the one or more maximum durations sent by the terminal device; and
configuring a length of a time window of the joint channel estimation for the terminal device in accordance with the one maximum duration selected.
